(19) United States
(12) Patent Application Publication
(10) Pub. No.: US 2007/0070933 A1
(43) Pub. Date: Mar. 29, 2007

(54) Methods and systems for providing highly resilient IP-RANs

(76) Inventors: Mun-Choon Chan, Singapore (SG); Ramachandran Ramjee, Summit, NJ (US); Tian Bu, Edison, NJ (US)

Correspondence Address: HARNESS, DICKEY & PIERCE, P.L.C., P.O. BOX 8910, RESTON, VA, 20195, US

(21) Appl. No.: 11/236,735

(22) Filed: Sep. 28, 2005

(51) Int. Cl. H04Q 7/00

(52) U.S. Cl. 370/328

(57) ABSTRACT

Estimates are provided for the number of links needed in a Internet Protocol-Radio Access Network (IP-RAN) to ensure the IP-RAN is resilient to base station and radio network controller type failures.

### BACKGROUND OF THE INVENTION

Currently, third-generation, wide-area wireless networks based on CDMA2000 and UNITS are being deployed throughout the world. These networks provide both voice and high-speed data services. In order to reduce the cost of these services to attract more subscribers, network operators must reduce their capital and operating expenses.

Typically, such networks include base stations and radio network controllers (RNCs) that are connected by expensive point-to-point T1/E1 links. In such a point-to-point architecture a group of RNCs may be shared by a small set of base stations. During hot-spot and peak hours, this architecture is susceptible to significant call blocking. To avoid this, a network operator typically needs to appropriately add capacity to an RNC. This, however, increases capital costs.

Furthermore, in this architecture, an RNC itself may be a single point of failure. To account for this possibility, network operators typically build in redundancy which increases the cost of each RNC.

One way to reduce these costs is to replace point-to-point links with an Internet Protocol-based Radio Access Network (IP-RAN). FIGS. 1(a) and (b) depict examples of a conventional RAN and an IP-RAN, respectively.

An IP-RAN provides a number of benefits, including:
Scalability: An RNC's capacity may be shared among a larger number of base stations. By load balancing calls across different RNCs, call blocking and dropping can be lowered.
Reliability: When base stations are connected to multiple RNCs, the failure of one RNC can be overcome by transferring calls from one RNC to another, thereby increasing reliability.
Flexibility: Point-to-point links are expensive and cannot be shared. In contrast, the links in an IP-based RAN benefit from the use of statistical multiplexing and may also be shared with other applications (such as wired network traffic) as long as an appropriate quality-of-service (QoS), can be ensured (for example, using MPLS tunnels).

While studies have shown that it is feasible for an IP-RAN to support QoS requirements, the question of connectivity, i.e. how best to connect base stations to RNCs in an IP-RAN, had not been addressed by any research literature to our knowledge until the inventors addressed this in their research paper entitled, Connectivity and performance of IP-based CDMA Radio Access Networks (Infocom, April, 2004), the disclosure of which is incorporated in full herein as if set forth in full herein.

The inventors' research introduced techniques for optimizing the connection of base stations to RNCs in an IP-RAN. It is worthy of note that this was a hard problem to solve because, even for a simple network of 100 base stations and 10 RNCs, the number of possible connection patterns between the base stations and the RNCs is enormous (e.g., 2¹⁰⁰⁰).

The inventors were also the first to introduce techniques that assign an appropriate RNC to an incoming call once an optimal connection pattern was determined. These techniques ensure that call dropping (handoff calls) and call blocking (new calls) rates are minimized, with priority given to handoff calls.

One technique, known as Min-Load-1 performed significantly better than other techniques. Its performance was very close to that of more complicated schemes.

Though the inventors' earlier research introduced techniques for solving base station connectivity and RNC assignment problems for IP-RANs, there remains the problem of determining how many links to include within an IP-RAN to allow the IP-RAN to operate effectively (i.e., in a connected state) when failures occur, the so-called “resiliency” of a network.

It is therefore desirable to provide for methods and systems that provide highly resilient IP-RAN networks.

### SUMMARY OF THE INVENTION

We have recognized that it is possible to estimate the number of links necessary to construct highly resilient IP-RANs. The number of additional links required over and above a single connected IP-RAN are relatively few.

In one embodiment of the invention, a resilient, IP-RAN comprises one or more base stations connected to one or more RNCs to form a network having an arc connectivity of 1 or more, wherein the IP-RAN includes a plurality of links whose number is a certain magnitude more than a number of links in a single connected IP-RAN.

In yet further embodiments of the invention, the number of links is substantially equal to 10% or 20% more than the number of single-connected links. For the 20% embodiment, the IP-RAN accommodates a failure of one of the base stations substantially effectively as a fully connected RAN.

In still yet another embodiment, when the arc connectivity is set to 2 and the number of links is substantially equal to twice the number of links in a single-connected IP-RAN, the resulting IP-RAN accommodates a single RNC failure substantially effective as a fully connected RAN.

### BRIEF DESCRIPTION OF THE DRAWINGS

FIG. 1(a) depicts a conventional RAN architecture;

FIG. 1(b) depicts an IP-RAN architecture;

FIGS. 2 and 3 depict examples of balanced graphs;

FIGS. 4 and 5 depict examples of RNC accessibility graphs that correspond to the balanced graph in FIGS. 2 and 3;

FIGS. 6(a) and 6(b) depict graphs of rejection probabilities for RANS when a base station fails; and

FIGS. 7(a) and 7(b) depict graphs of rejection probabilities for RANS where an RNC fails.

### DETAILED DESCRIPTION OF THE INVENTION

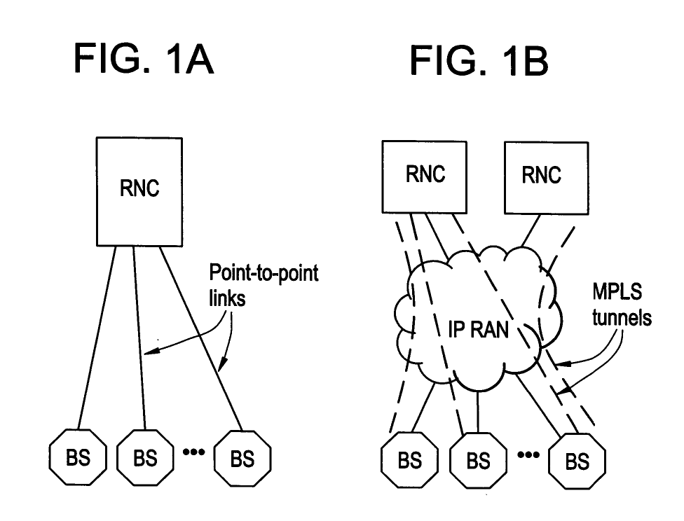

Referring to FIGS. 1(a) or 1(b) there is shown a network architecture that includes the following components: a set of RNCs, a set of base stations, a set of communication links, that connect the base stations to the RNCs and a set of users. Note that in practice, the links may take the form of either a T1 leased line, an ATM connection or an MPLS path. Note also that many logical links may traverse the same physical link. This logical connection assures a Quality of Service necessary to ensure that CDMA soft handoffs function correctly. A user in the network can be either active or idle. A user, whether active or idle, is associated with a base station. An active user needs access to the radio resources of a base station and to the processing resources of an RNC. The links, L, may make up either a RAN (FIG. 1(a)) or IP-RAN (FIG. 1(b)) that connects the base stations to the RNCs. In general, each RNC performs a number of functions, including soft handoffs, reverse inter-loop power control, and termination of Radio Link Protocol for data users.

As indicated before, the inventors' earlier research explored the question of what algorithm or technique should be used to assign a call to an RNC (i.e, to a base station responsible for the call) so that call blocking and dropping rates are minimized for a given RAN. A load-balancing technique known as Min-Load-1 was determined to be the most attractive technique.

Before we proceed further, we need to define some concepts that were used by the inventors in their earlier research. One such concept is referred to as “graph connectivity”.

A graph is said to be connected if there is at least one path between every pair of nodes. The arc connectivity of a connected graph is the minimum number of arcs whose removal from the graph disconnects it into two or more components. For example, with N RNCs (e.g., N=2) and M base stations (M>N), a mesh connectivity has M×N links and is of arc connectivity N (e.g., N=2).

The approach used by the inventors in their research was to focus on a set of balanced graphs with properties that are desirable in a homogeneous network where RNCs have the same capacity and the base stations have the same average load. Each element in this set of balanced graphs has a different number of links L. The members of this set can be enumerated by varying the number of links L from M to NM. By focusing on this set of balanced graphs, the inventors discovered that the number of possible links could be reduced from 2^{NM} to NM. Given that there is very little known about the impact of connectivity on homogeneous networks, the inventors focused on the homogeneous network case. Heterogeneous networks are discussed briefly in subsequent sections.

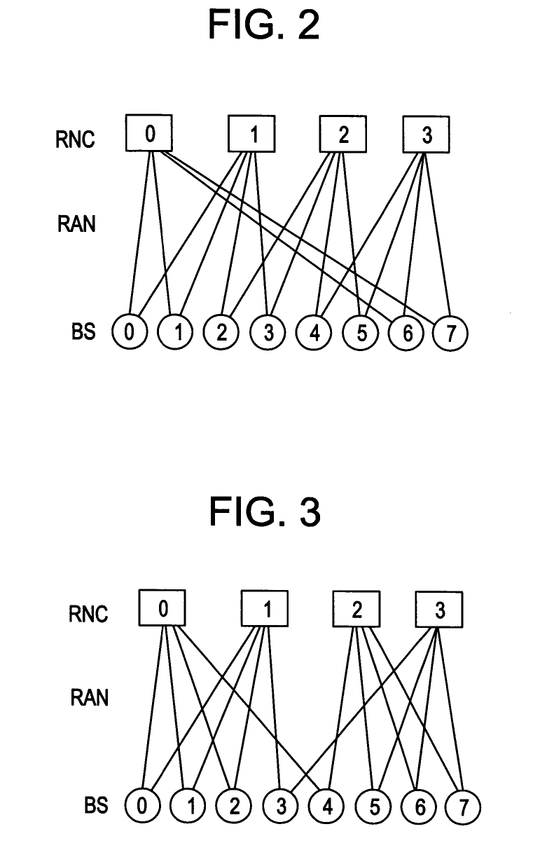

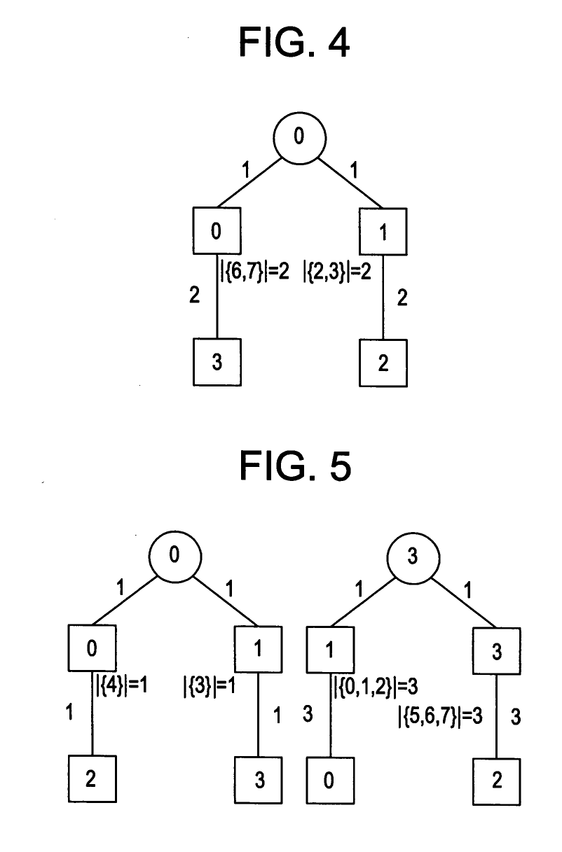

Closely related to a balanced graph is an RNC accessibility graph. Such a graph was also discussed in detail in the inventors' earlier research. FIGS. 2 and 3 depict examples of some balanced graphs while FIGS. 4 and 5 depict the RNC accessibility graphs that correspond to the balanced graphs in FIGS. 2 and 3, respectively.

A balanced graph whose corresponding RNC accessibility graph (in a full-mesh connected network) is also balanced was presented and discussed in the inventors' earlier research. For present purposes, it is sufficient to point out that the concepts of balanced graphs and an RNC accessibility graphs introduced by the inventors in their earlier research reduced the so called “state space” of possible connectivity patterns from 2^{NM} to NM, while maximizing performance.

As indicated above, the inventors' earlier research concluded that a Min-Load-1 technique was the most useful in assigning an RNC to a base station. In arriving at this conclusion, it should be noted that the inventors compared various Min-Load, Optimal, and Min-Load-k techniques/algorithms. The details concerning these comparisons are set forth in the inventors earlier research. As the astute reader will recognize, the Min-Load-1 technique that was ultimately selected is a variant of a Min-Load-k technique.

Another discovery that came from the inventors' earlier research was the realization that it is important to keep k as small as possible because a large k incurs more hard handoffs and longer call setup times.

We now turn to a discussion of the subject matter of the present invention, namely, an estimation of the number of links needed to be included with an IP-RAN to make it sufficiently resilient against failures.

In general, there are three possible types of failures: link failures, base station failures and RNC failures. However, because the failure of a single link is, in the worst case, as serious as one base station failure when the base station the link connects to is singularly connected, we will not present the evaluation of single link failure.

### Single Base-Station Failures

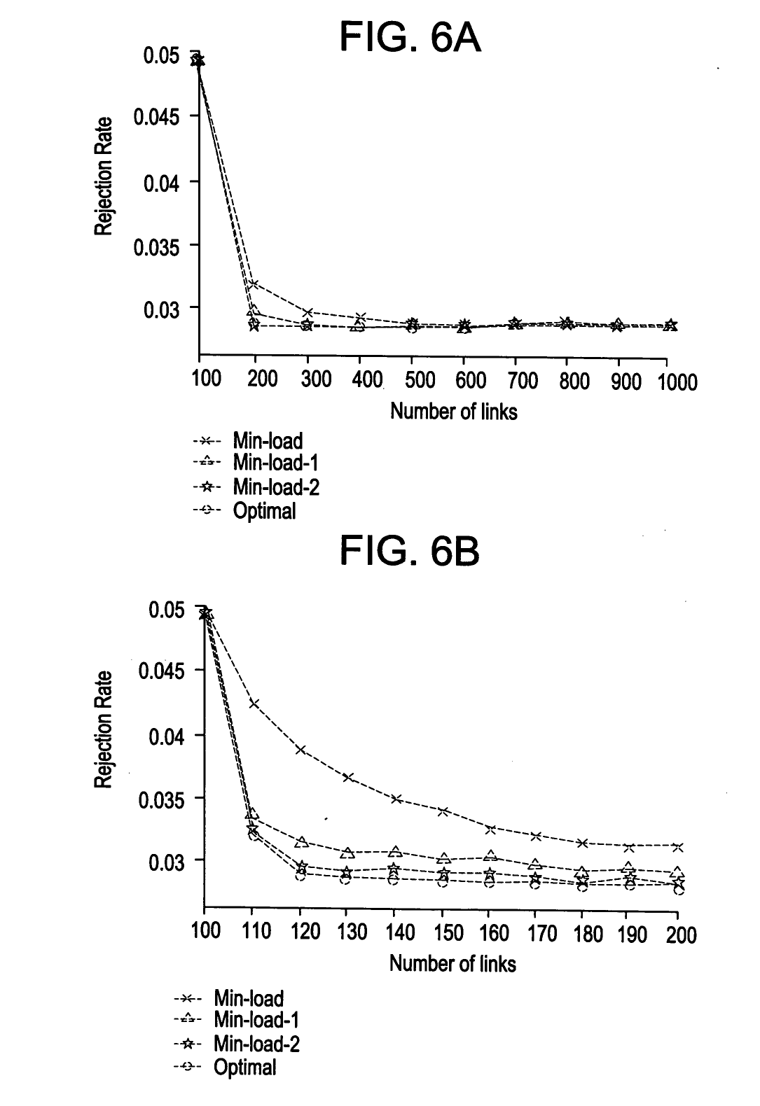

In accordance with one embodiment of the invention, a highly resilient IP-RAN can be designed to absorb a single base station type of failure. Because a minimum connected balanced graph is uniform in its connectivity, we can simply randomly pick any base station to fail. FIG. 6(a) plots the rejection probability ( i.e., the ratio of the sum of blocked and dropped calls to the number of total calls; measures the fraction of calls that are accepted) for a single-connected RAN to a RAN having an arc connectivity of ten (“fully connected”) after one base station fails. As shown, the rejection probability drops dramatically when the RAN changes from a single-connected network to a network having an arc connectivity of 2. In sum, the inventors have discovered that an IP-RAN having an arc connectivity 2 is almost as resilient as a RAN where each base station is connected to all RNCs (“full mesh-connectivity”, or “fully connected” for short). In addition, FIG. 6(a) illustrates the fact that the Min-Load-1 load-balancing technique is superior to an alternative technique (Min-Load) and almost as good as another alternative technique (Min-Load-2), i.e., the differences are minimal. What can be said, in sum, at this point is that a RAN with an arc connectivity of 2 is almost as resilient as one with an arc connectivity of 10

We now compare the resiliency of a RANs with arc connectivities of 1 and 2. FIG. 6(b) depicts the impact of one base station's failure for a single-connected RAN to a RAN that has an arc connectivity of 2. For this scenario, the base station with the highest connectivity was chosen as the source of the failure so that the resulting rejection probability is a worst case rejection probability (i.e., after such a failure, a RAN may be partitioned). From FIG. 6(b) it can be seen that the rejection probability is reduced significantly as one link per RNC is added to an RAN having an arc connectivity of 1. Adding another link per RNC reduces the probability further but not as significant as adding the first link per RNC. Similarly, adding more and more links does not help to further reduce the rejection probability. In the case of a single base station failure, an RAN having an arc connectivity of 1 with two additional links per RNC appears to be as resilient as one with more connections.

When the Min-Load-1 load balancing technique is used (and we assume it is), the minimum connectivity (i.e., number of links) required to allow an IP-RAN to achieve good performance is equal to the number of links in a single-connected graph plus 10 links (normalized to 10%) added in a balanced way. When a base station fails, the connectivity (i.e., number of links) needed to ensure an IP-RAN's resilience is approximately the number of links in a single-connected graph plus 20 links (i.e., 20%).

### Single RNC Failures

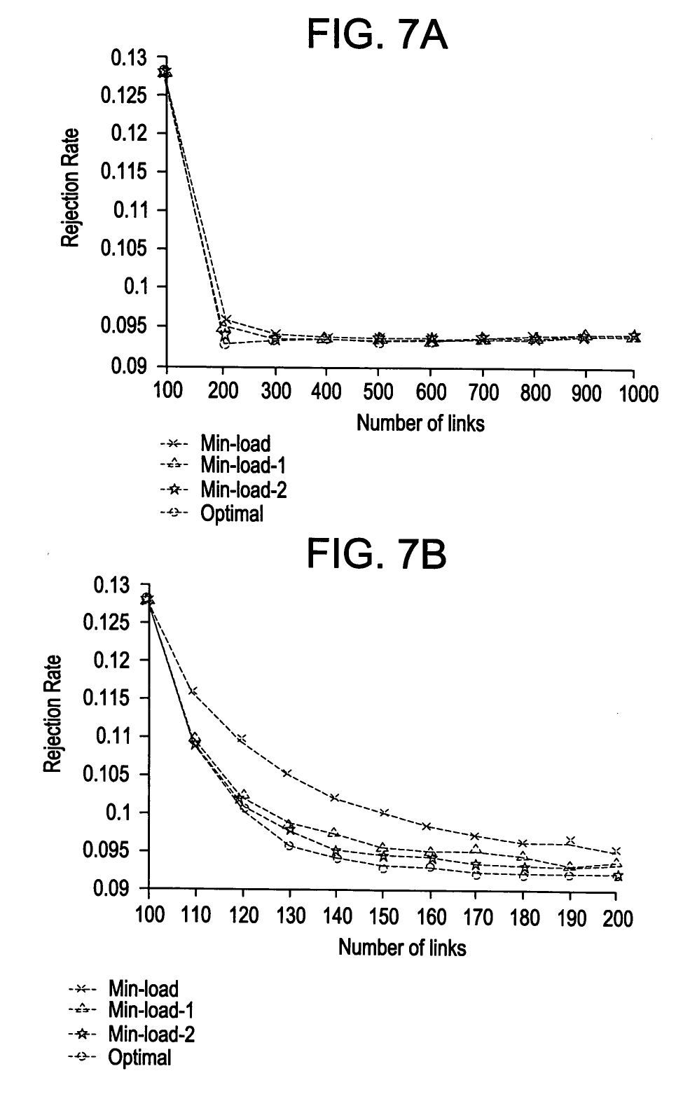

FIG. 7(a) plots the rejection probability for a RAN having an arc connectivity of one to ten during the failure of a single RNC. Because the graph is uniform, a random RNC may be chosen to fail. From FIG. 7(a) it can be seen that the rejection probability drops dramatically when comparing a single-connected RAN to one having an arc connectivity of 2. FIG. 7(a) also shows that the rejection probability of a highly connected RAN is similar to a RAN having an arc connectivity of 2. In another embodiment of the invention, the inventors discovered that adding a number of links that is twice as much as the number of links in a single-connected RAN ensures that a so-configured IP-RAN is resilient (i.e., as much as a fully-connected RAN).

In sum, the inventors have discovered that: (a) a RAN having an arc connectivity of 2 is much more resilient to a single RNC failure than a RAN having an arc connectivity of 1; and (b) adding more links to a RAN having an arc connectivity of 2 does not improve a RAN's resilience to a single RNC failure significantly; (c) adding twice the number of links ensures resiliency.

FIG. 7(b) depicts a comparison of rejections rates for a single-connected RAN and a RAN having an arc connectivity of 2. In FIG. 7(b), the x-axis represents the number of links in a RAN. Because the graph is uniform, a random RNC may be chosen to fail. The results shown in FIG. 7(b) illustrate the fact that there is a significant difference in terms of resilience between a single-connected RAN and one having an arc connectivity of 2. For example, the rejection probability decreases rapidly when the first links are added but then the improvement tapers off after that. Adding 5 links per RNC appears to be the turning point where the curve flattens.

In yet further embodiments of the invention, the same connectivities at both higher and lower loads have found that the turning point where the rejection rate drops significantly changes with load (“turning point”). For example, the turning point moves towards a RAN having an arc connectivity of 2 when the load decreases. It can be argued that a minimum connected balanced graph having an arc connectivity of 2 is the minimum connectivity required to maintain a low rejection rate after an RNC failure because any graph with a lower connectivity will be partitioned (i.e., one or more base stations are not connected to any RNC) after an RNC failure.

In sum, the inventors have discovered that in order to make a RAN resilient to RNC failures at any load, an arc connectivity of 2 is necessary.

In the approach presented so far, we have assumed that the IP-RAN is homogeneous. That is, all of the base stations have the same average load, all of the RNCs have the same capacities and all of the link costs are the same.

In a further embodiment of the invention, the techniques discussed herein and in the inventors' earlier research may be extended to a heterogeneous IP-RAN.

One approach is to map a heterogeneous IP-RAN to a constrained homogeneous one using the following strategy.

The heterogeneous RNCs/base stations may be split into homogeneous logical RNCs/base stations with capacities/loads equal to the highest common denominator of all the RNCs/base stations. In order to mimic the physical locality of the RNCs/base stations, whenever a logical base station is connected to a logical RNC in a connectivity model, additional links are added between all the corresponding logical base stations of the original heterogeneous base station to all the corresponding logical RNCs of the original heterogeneous RNCs.

It should be understood that this transformation is just one possible way of analyzing connectivity in heterogeneous networks.

In the discussion above, we have set forth some estimates of the number of links required in an IP-RAN to ensure its resiliency in the face of a base station or RNC failure. Underlying these estimates is the assumption that an RNC assignment technique, called Min-Load-1, described in the inventors' earlier research is used as a load balancing technique to assign an incoming call (i.e., new call or a handoff) to an RNC.

The estimates presented herein provide additional support for deploying IP-based RANs because they suggest that it is possible to enhance the resiliency of existing current point-to-point RANs by adding a relatively small number of additional links.

We claim:

1. A resilient, Internet Protocol, Radio Access Network (IP-RAN) comprising:
one or more base stations connected to one or more radio network controllers (RNCs) to form a network of links having an arc connectivity of 1 or more,
wherein the IP-RAN includes a plurality of links whose number is a certain magnitude more than a number of links in a single-connected IP-RAN.

2. The IP-RAN as in claim 1 wherein the number of links is substantially equal to 10% more than the number of links in a single-connected IP-RAN.

3. The IP-RAN as in claim 2 wherein the IP-RAN does not effectively accommodate a link failure.

4. The IP-RAN as in claim 1 wherein the number of links is substantially equal to 20% more than a number of links in a single-connected IP-RAN.

5. The IP-RAN as in claim 4 wherein the IP-RAN accommodates a failure of one of the base stations.

6. The IP-RAN as in claim 1 wherein the arc connectivity is 2 or more and the number of links is substantially equal to twice the number of links in a single-connected IP-RAN.

7. The IP-RAN as in claim 6 wherein the IP-RAN accommodates a single RNC failure.

8. IP-RAN as in claim 1 wherein a call is assigned to an RNC using a Min-Load-1, load balancing technique.

9. A resilient, Internet Protocol, Radio Access Network (IP-RAN) comprising:
one or more base stations connected to one or more radio network controllers (RNCs) to form a network having an arc connectivity of 1 or more,
wherein the IP-RAN includes a plurality of links whose number is substantially equal to 20% more than a number of links in a single-connected, IP-RAN.

10. The IP-RAN as in claim 9 wherein the IP-RAN accommodates a failure of one of the base stations.

11. The IP-RAN as in claim 9 where a call is assigned to an RNC using a Min-Load-1, load balancing technique.

12. A resilient, Internet Protocol, Radio Access Network (IP-RAN) comprising:
one or more base stations connected to one or more radio network controllers (RNCs) to form a network having an arc connectivity of 2 or more,
wherein the IP-RAN includes a plurality of links whose number is substantially equal to twice the number of links in a single-connected, IP-RAN.

13. The IP-RAN as in claim 12 wherein the IP-RAN accommodates a single RNC failure.

14. The IP-RAN as in claim 12 wherein a call is assigned to an RNC using a Min-Load-1, load balancing technique.

15. A method for providing a resilient, Internet Protocol, Radio Access Network (IP-RAN) comprising:
Connecting one or more base stations to one or more radio network controllers (RNCs) to form a network of links having an arc connectivity of 1 or more,
wherein the IP-RAN includes a plurality of links whose number is a certain magnitude more than a number of links in a single-connected IP-RAN.

16. The method as in claim 15 wherein the number of links is substantially equal to 10% more than the number of links in a single-connected IP-RAN.

17. The method as in claim 16 wherein the IP-RAN does not effectively accommodate a link failure.

18. The method as in claim 15 wherein the number of links is substantially equal to 20% more than a number of links in a single-connected IP-RAN.

19. The method as in claim 18 wherein the IP-RAN accommodates a failure of one of the base stations.

20. The method as in claim 15 wherein the arc connectivity is 2 or more and the number of links is substantially equal to twice the number of links in a single-connected IP-RAN.

21. The method as in claim 20 wherein the IP-RAN accommodates a single RNC failure.

22. The method as in claim 15 further comprising assigning a call to an RNC using a Min-Load-1, load balancing technique.

23. A method for providing a resilient, Internet Protocol, Radio Access Network (IP-RAN) comprising:
connecting one or more base stations to one or more radio network controllers (RNCs) to form a network having an arc connectivity of 1 or more,
wherein the IP-RAN includes a plurality of links whose number is substantially equal to 20% more than a number of links in a single-connected, IP-RAN.

24. The method as in claim 23 wherein the IP-RAN accommodates a failure of one of the base stations.

25. The method as in claim 23 further comprising assigning a call to an RNC using a Min-Load-1, load balancing technique.

26. A method for providing a resilient, Internet Protocol, Radio Access Network (IP-RAN) comprising:
connecting one or more base stations to one or more radio network controllers (RNCs) to form a network having an arc connectivity of 2 or more,
wherein the IP-RAN includes a plurality of links whose number is substantially equal to twice the number of links in a single-connected, IP-RAN.

27. The method as in claim 26 wherein the IP-RAN accommodates a single RNC failure.

28. The method as in claim 26 further comprising assigning a call to an RNC using a Min-Load-1, load balancing technique.
